(19) United States
(12) Patent Application Publication
(10) Pub. No.: US 2010/0201637 A1
(43) Pub. Date: Aug. 12, 2010

(54) TOUCH SCREEN DISPLAY SYSTEM

(75) Inventors: Michael L. Herne, Saratoga, CA (US); Igor Plotnikov, Sunnyvale, CA (US)

Correspondence Address: PERKINS COIE LLP, P.O. BOX 1208, SEATTLE, WA, 98111-1208, US

(73) Assignee: Interacta, Inc., Sunnyvale, CA (US)

(21) Appl. No.: 12/369,655

(22) Filed: Feb. 11, 2009

(51) Int. Cl. G06F 3/041

(52) U.S. Cl. 345/173

(57) ABSTRACT

A touch screen display system combines the use of electromagnetic radiation emitters with shadow detection to determine the precise location or other touch related parameters of an object touching the display screen. In one embodiment the system comprises a display screen, a plurality of laser emitters disposed at a periphery of the display screen; a plurality of beam shapers to shape emissions from the emitters into fan beam patterns, and a plurality of detectors disposed at the periphery of the display screen to detect laser emissions of the laser emitters; and a processor to determine a location where an object touches the display screen, based on outputs of the detectors.

### FIELD OF THE INVENTION

At least one embodiment of the present invention pertains to information display systems, and more particularly, to a touch screen display system.

### BACKGROUND

Touch screen displays are becoming more common in modern computing and communication systems. A touch screen display allows a user to provide a command, selection or other type of input to a machine by touching the display at an appropriate location with an object, such as a finger or a stylus. This provides a more intuitive (i.e., more user-friendly) way for users to interact with the system than conventional mouse- or trackball-based systems and the like.

There are many touch screen vendors on the market today, predominantly servicing manufacturers of point-of-sale (POS) machines, casino game consoles, airport kiosks, smart phones, etc. The screen size is usually small (e.g., smart phones) to medium (e.g., kiosks). The most common touch detection technologies used today in touch screen systems are resistive, capacitive (including projective capacitive) and acoustic based detection.

New applications are creating a demand for larger touch screens. However, larger screens create a number of design problems. In particular, insufficient speed and response time, lack of multi-touch detection capability, lack of flexibility of using hand, finger or stylus, and inadequate scalability make the use of resistive, capacitive or acoustic technologies problematic for large screens.

Another commonly used type of touch screen technology is optical/infrared (IR). This technology has been successfully applied to very large screens. The main reason is that its cost scales linearly, not squarely, with the screen size. The traditional way to build an IR touch sensor is to create a rectangular (x,y) grid of discrete light imaging diodes (LEDs) and photoreceptors on opposite sides of the frame of the display screen. Each photodiode on one side of the frame has a corresponding LED emitter on the opposite side of the frame, and an interruption of light is detected when an object touches or comes into close proximity with the screen.

One problem with this approach is that it is not well suited to support multi-touch detection capability. With only two light sources (e.g., horizontal and vertical) for each coordinate pair (x,y), the system cannot unambiguously detect two or more simultaneous touch points. If one point is detected first and then state information is used (e.g., the saved location and time of the first touch point), then a second point can be determined unambiguously. However, the time delay involved is a significant drawback given the high probability that both points are touched simultaneously in any given instance.

Also, existing implementations use IR diodes that do not produce strongly collimated light. With detection fields in the 1 meter and above range, detecting millimeter-size objects touching the display surface is a challenge. Consider a millimeter-size object close to the light source edge. Due to light scatter from unoccluded adjacent emitters, an object this size may not even be seen by the receiver.

Another approach to touch screen technology is a camera based optical approach. The essence of this approach is to use cameras at different corners of the screen, while the opposite sides of the frame have a special IR-lighted bezel (perimeter of the display). The bezel provides enough diffused light to create high contrast images at the corner cameras. When an object is introduced close to the surface of the screen, it occludes the bezel from the cameras, creating a high contrast image on each camera's charge-coupled device (CCD). The center of the object can be triangulated from the locations of the images generated in the two cameras.

The camera based design suffers from several drawbacks, however. The design depends on optics in the camera to focus on the field of view. But the required depth of field can vary greatly, ranging from centimeters to meters. Because the region in focus is quite narrow compared to the depth of the field of view, significant portions of the field of view may be out of focus. In regions that are out of focus, accurate detection of location and size of a touch point will be error prone due to inability to precisely locate the object's edges. Further, objects that are very small but still relevant (e.g., a 1 mm stylus) in the out of focus region are very difficult if not impossible to detect accurately.

The focus problem also effects what is called “pre-touch”, a scenario in which the system detects an object prior to an actual touch. The farther the distance from the display surface that pre-touch occurs, the less useable the system becomes. Some pre-touch is acceptable, however, due to focus issues, the pre-touch region in the camera based system tends to vary over the field of detection. In some regions of the display, pre-touch is a significant problem.

The camera based system also requires high contrast between the object and the perimeter of the display. This is accomplished by a passive or active lighting of the perimeter of the display (the bezel). Thus, an object placed on the display appears dark against a bright field. Without this controlled lighting condition, detection is extremely difficult.

Systems that use this design usually use just two cameras, for example, one at the top left of the display and one at the top right of the display, with the left, bottom, and right edges of the display having an illuminated bezel. With two cameras, the region near the top of the display (i.e., between the two cameras) suffers from very poor accuracy. Further, two cameras can only unambiguously detect a single touch point. Adding cameras in the other corners potentially could solve this problem. However, placing cameras in the other corners creates the problem of where to locate the camera so that it does not disrupt the other cameras' views of the illuminated bezel. To keep pre-touch to a minimum, all the bezel and cameras need to be in the same horizontal plane, or nearly so. With pre-touch being a major use problem, solving this problem is difficult if not impossible.

Another camera based approach uses the property of frustrated internal reflection. In this approach a sheet of glass (or other material with similar optical properties) is placed over the display surface as an optical transmission medium. IR light is then coupled into the glass from the edges. When an object touches the surface of the medium, it causes the IR light to reflect out of the medium. A IR camera placed behind the glass, with the camera oriented and focused on the entire sheet of glass will see bright spots of light were the touches occur. However, this design will only work with rear projection systems, precluding its use on flat displays such as plasma, LCD, and other ultra thin displays. The rear depth needed for the camera and other optics of the rear projection system precludes use of this approach in systems designed for confined environments, such as offices and conference rooms.

### SUMMARY

The technology introduced here includes a touch screen display system which combines the use of electromagnetic radiation emitters with shadow detection to determine the precise location of an object touching or in close proximity to the display screen. In certain embodiments the emitters are laser emitters. The system provides both multi-touch detection and multi-user capability, with high precision and fast response time.

In one embodiment the system comprises a display screen, a plurality of emitters disposed at the periphery of the display screen; a plurality of beam shapers to shape emissions from the emitters into fan beam patterns; a plurality of detectors disposed at the periphery of the display screen to detect emissions of the emitters; and a processor to determine a location or other parameter of a touch event in which an object touches the display screen, based on outputs of the detectors.

In certain embodiments the system includes at least two laser emitters disposed at different corners of the display screen, and may include a laser emitter at each of four corners of the display screen. The location where an object touches the display surface can be determined by determining locations of shadows of radiation cast by the object upon two or more of the detectors. The detectors can be contact image sensors (CIS). The detectors can be mounted on a plurality of circuit boards physically coupled to form one or more contiguous linear arrays along the bezel.

In certain embodiments the system further includes a plurality of beam shapers, such as optical waveguides, each to modify the pattern of radiation from a different one of the emitters. In certain embodiments, each beam shaper modifies the radiation pattern of its corresponding emitter to be an approximately 90-degree fan beam pattern parallel to a display surface of the display screen and collimates the radiation in a direction perpendicular to the display surface. The system can further include an acoustic sensor, such as a piezoelectric sensor, to detect the event of an object touching a display surface of the display screen.

Advantages of this approach over prior systems such as the xy grid based approach include better resolution, smaller detectable touch-point size and faster response time, as well as the ability to provide multi-touch detection and multi-user functionality. This approach also avoids focus related problems associated with camera-based solutions. Further, the approach introduced here is suitable for use in flat displays such as plasma, LCD, and other ultra thin displays.

Note that while the embodiments described herein relate to a display system, the techniques introduced here are not necessarily limited in application to a display system or display device. The techniques introduced here could potentially be used for detecting touch location and other touch-related parameters on essentially any kind of surface.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 illustrates a touch screen system according to an embodiment of the invention;

FIG. 2 schematically illustrates how fanned laser beams from two laser emitters cast shadows of an object on the detector arrays;

FIG. 3 illustrates a beam shaper converting a laser beam into a horizontally fanned (decollimated), vertically collimated radiation pattern;

FIG. 4 is a block diagram showing major functional modules of a touch location processor in the processing unit;

FIGS. 5A through 5C illustrate schematically how the position of an object can be computed based on detected shadows, in at least one embodiment;

FIG. 6 is a block diagram illustrating the relevant elements of the processing unit;

FIG. 7 is a cross-sectional view of the display showing an example of the construction of the display system;

FIG. 8 illustrates an example of how linear arrays of optical sensors mounted on printed circuit boards (PCBs) can be chained together;

FIG. 9 schematically illustrates how two sensor PCBs can be coupled together at a corner of the display, with slots to accommodate a laser emitter and optics;

FIG. 10 shows how a prism can be used to allow sensors and a laser emitter to be raised off the surface of the display screen; and

FIG. 11 illustrates the approach of bouncing a laser beam off the surface of the display screen to achieve effectively a narrower beam.

### DETAILED DESCRIPTION

References in this specification to “an embodiment”, “one embodiment”, or the like, mean that the particular feature, structure or characteristic being described is included in at least one embodiment of the present invention. Occurrences of such phrases in this specification do not necessarily all refer to the same embodiment.

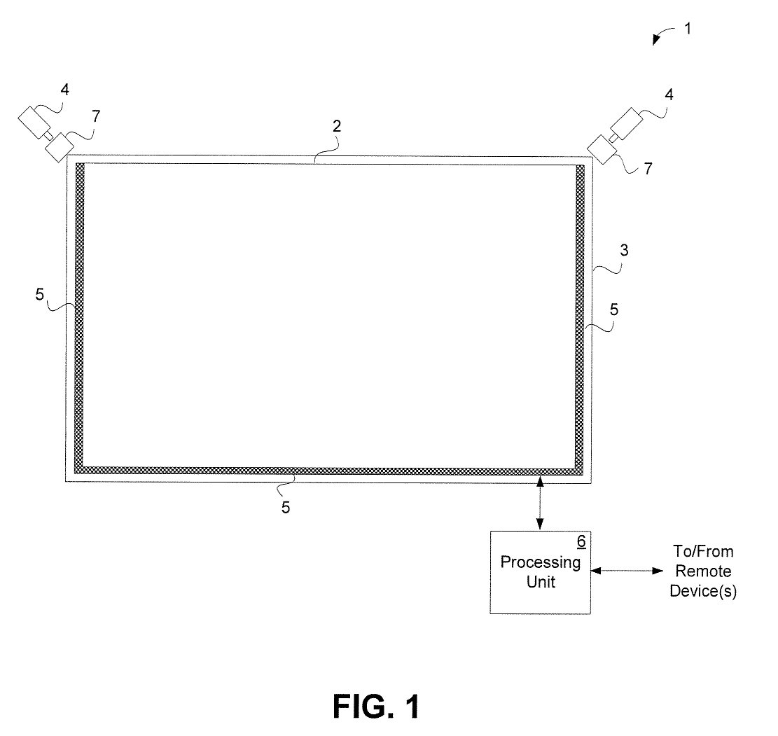

FIG. 1 illustrates a touch screen system that incorporates the technology introduced here. The system 1 includes a display screen 2 mounted in a bezel 3. Two or more electromagnetic radiation emitters 4 are mounted at different corners of the bezel 3. In at least some embodiments the emitters 4 are designed to emit IR light. Further, in at least some embodiments the emitters 4 are IR laser emitters, as will be generally assumed in the remainder of this description, to facilitate explanation. The emitters 4 are sequenced so that only one emitter is emitting at any given point in time.

A linear array of optical sensors (detectors) 5 is mounted to at least three of the sides of the bezel 3 that are opposite the laser emitters 4. Note that this configuration inverts the geometry of the conventional optical camera-based approach, among other differences.

A processing device 6 is coupled to all of the sensors 5 and includes functionality to process the sensor outputs to determine the location of a touch event (or multi-touch event) on the display screen 2, and potentially other parameters that are descriptive of the touch event (e.g., size of the touch point and speed or duration of the touch event) and to control the output of the display screen 2. In addition, the processing device 6 may have the capability to communicate with one or more other components and devices (not shown) of the system 1, such as other user input devices, and/or to communicate with one or more remote processing systems(not shown).

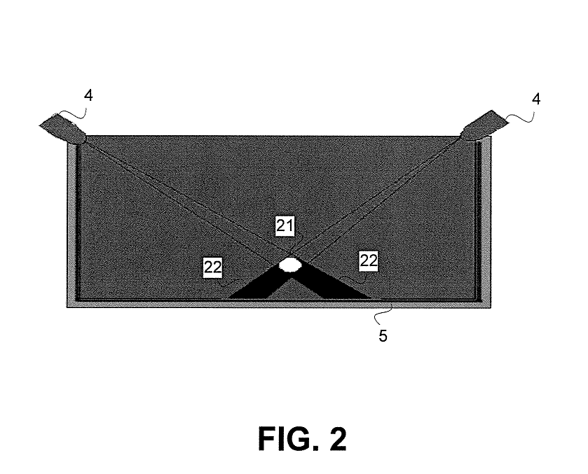

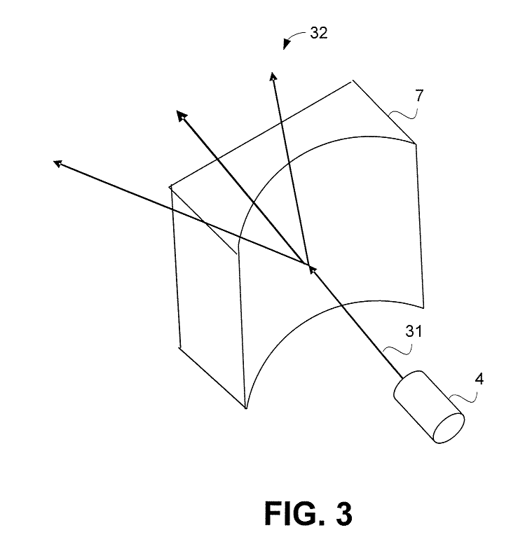

In one embodiment each laser emitter 4 is accompanied by a beam shaper 7, which can be an optical waveguide (e.g., a set of horizontal lens line optics), such as shown in FIG. 3. The beam shaper 7 converts the laser beam 31 from an emitter 4 into a fan-shaped radiation pattern (“fan beam”) of light 32, that is spread 90 degrees over the display screen 2 and oriented horizontally (i.e., parallel to the plane of the display screen 2). Also in certain embodiments, the beam shaper 7 collimates the beam at about 1 mm vertically (perpendicular to the plane of the display screen 2). By “fan-shaped”, what is meant here is the shape of a two-dimensional lengthwise cross-section of a cone through its center axis; examples of such a radiation pattern are illustrated in FIGS. 2, 3 and 5A-5C, as discussed below. Optics that can produce this shape of radiation pattern are well understood, and are used in, for example, commodity laser level products. In other embodiments, a form of beam shaper other than an optical waveguide may be used to the same effect. In still other embodiments, instead of using a beam shaper 7 to produce a fan beam, each of the laser emitters 4 is controlled so as to sweep its emitted laser beam rapidly through a range of angles across the display surface.

In certain embodiments, such as where the emitters 4 are mounted at the corners of the display screen 2 as in FIG. 2, the emitters 4 and beam shapers 7 are mounted and configured so that the outer edges of the fan beam from any given emitter 4 are aligned with one vertical edge and one horizontal edge of the display screen 2, i.e., a 90-degree fan beam pattern. In other embodiments, the emitters 4 are not mounted at the corners of the display screen 2, and the beams they generate are not necessarily 90-degree fan beams. In one alternative embodiment, one or more of the emitters 4 are mounted at an intermediary point along the perimeter of the display screen 2. For example, two emitters 4 might be positioned at the mid-point along the top edge of the display screen 2 and may generate 90 degree fan beams aligned “back-to-back”, to cover the entire display area. This configuration may be advantageous for use with a very large display screen 2.

An advantage of using a fan beam is that each emitter in the system provides non-redundant information, in contrast with a rectangular grid-based optical detection system where adding emitters would not provide any additional non-redundant information. The non-redundant information provided by each fan beam emitter in the technique introduced here can be used to detect touch location and other characteristics, particularly to eliminate “ghost regions” (false touch regions). In particular, the use of one or more fan beams enables the elimination of ghost touch points without maintaining touch point state information (history), or the elimination of a greater number of ghost points for a given amount of maintained touch point state information than would be possible with a rectangular grid based emitter-detector system.

The sensors 5 along the edge of the opposite bezel can be linear CIS arrays of the sort commodity used in various commodities scanners, fax machines, etc. Such CIS arrays are typically formed of charge-coupled device (CCD) based detectors. Note that the system introduced here does not require focusing optics, in contrast with a conventional camera-based system. This is because the technique introduced here is based on detection of shadows, whereas the conventional camera-based system actually builds an image on each sensor (camera). Consequently, the system introduced here does not have a depth of field problem as a conventional camera-based system does.

In operation, in one embodiment, the emitters 4 fire sequentially in a repeating loop. An object 21 in contact with or close to the display screen 2 will intersect the sheet of light and create a shadow 22 on a sensor array 5, as illustrated in FIG. 2 (the beam shapers 7 are not shown in FIG. 2 to simplify illustration). The centers and sizes of the shadows 22 for two laser emitters can be easily determined and used to triangulate the position and size of the object 21. The emitters 4 are fired sequentially so that the shadows can be correctly registered and attributed to the correct emitter. As a result, the overall touch sensor response time is about 4 times the data collection time for each corner.

As noted above, in at least some embodiments the emitters 4 are IR laser emitters. Note that it is preferable to use a point light source in the plane parallel to the display surface. The minimum detectable object size is related to how well the emitter 4 approximates a point source in optical terms. Also, the performance of the system improves as the detectors get more light per unit time from the emitters 4. If the power of the emitters 4 were unbounded, then an ordinary sub-millimeter light source would likely be adequate. However, practical power restrictions exist.

Therefore, use of a laser with appropriate beam shaping properties is a good way to achieve a low power source with high power densities at the detectors and good approximation of a point light source. As the size of the touch surface increases, the superiority of a laser based solution will increase. However, for smaller touch surfaces, other types of emitters such as small (sub-millimeter) IR LEDs may be adequate.

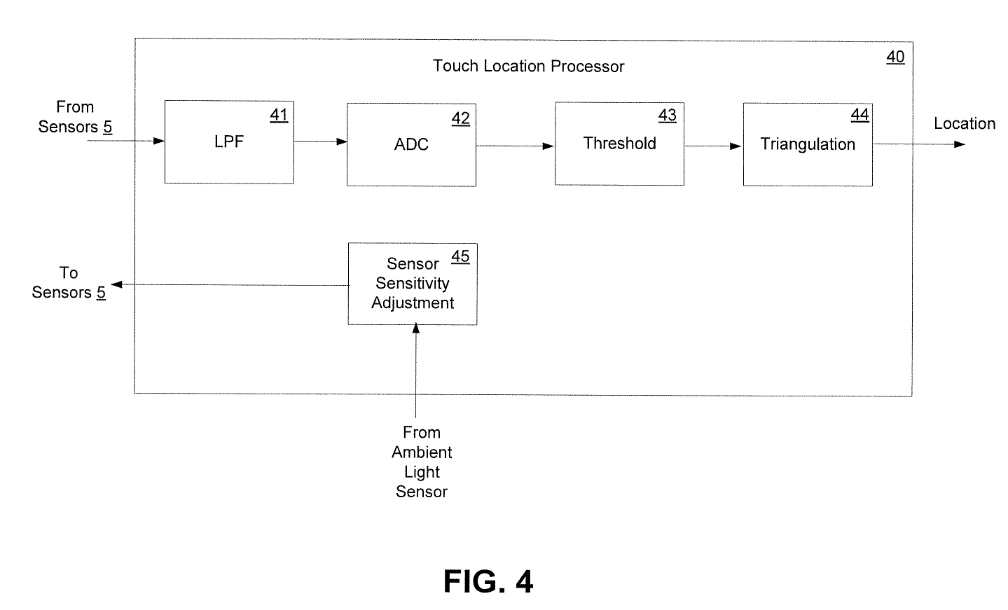

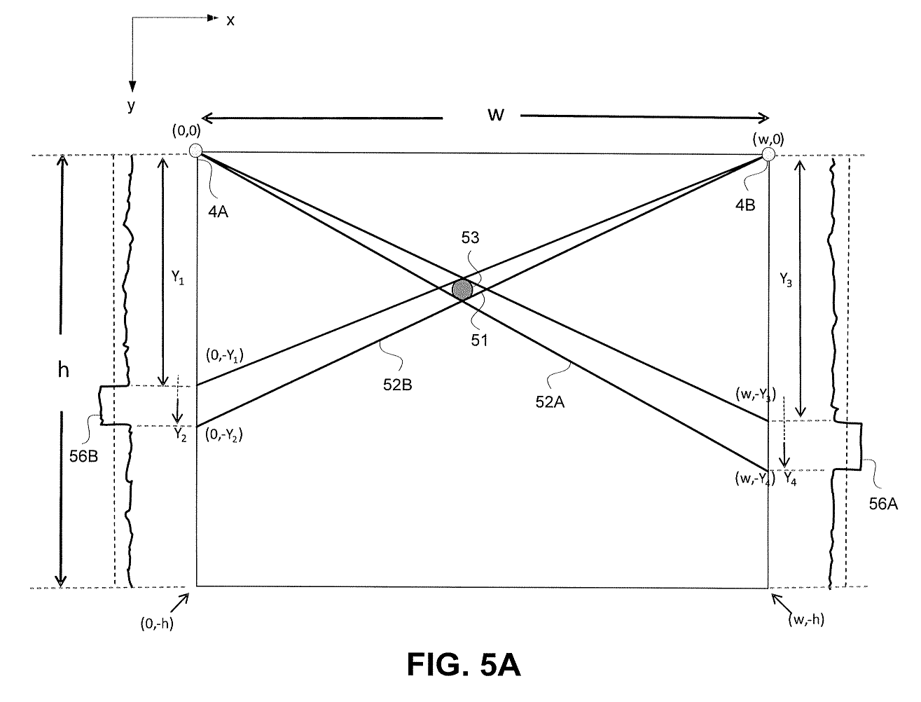

Touch location detection is now explained further with reference to FIGS. 4 and 5. Note that other touch related parameters can also be detected, such as size of touch point, etc. FIG. 4 is a block diagram showing the major functional modules of a touch location processor 40 in the processing unit 6, according to one embodiment. At a given point in time, the outputs from the sensors 5 are initially passed through a low pass filter 41 to remove noise and diffraction effects. The output of the filter 41 is then converted to a digital value by an analog to digital converter (ADC) 42 and then applied to a threshold module 43, which applies a threshold function to differentiate between direct illumination and shadows. The thresholded filtered signals are then processed by a triangulation module 44 which determines and outputs the position of the object.

In one embodiment, the triangulation module 44 first identifies the two edges of each shadow 22 of the object on the sensors 5 from a particular laser emitter 4, then determines the angle from that emitter to each edge of the shadow, and then bisects that angle to determine the angle from the emitter to the object 21. The triangle formed by two lasers beams and the angles to the object 21 from the display corners can be used to determine the position of the object 21 via triangulation. Having four laser emitters and their respective shadows allows for better accuracy as well as multi-touch detection, as discussed further below. In addition, the diffraction sidebands can be used to very accurately determine the size of the object.

It may be desirable to adjust the sensitivity of the sensors 5 for the ambient lighting conditions. The sensitivity adjustment can be performed by a sensitivity adjustment module 45 in the touch location processor 40 (as shown) or elsewhere in the processing unit 6. Alternatively, the sensitivity adjustment can be implemented in the sensor module itself. The sensitivity adjustment module 45 receives input from an ambient light sensor (not shown). With no object in the field of view, the sensitivity of each group of sensors 5 can be electronically adjusted to be near peak output but not saturated. In such a state, an occlusion of the primary emitter will cause a significant change in the sensor's output. In one embodiment, the sensitivity adjustment occurs continuously but with a slow response time (e.g., seconds to minutes).

FIGS. 5A through 5C illustrate schematically how the position of an object can be computed, in at least one embodiment. While triangulation can be used as explained above, the approach of FIGS. 5A through 5C is based on identifying intersecting lines in a Cartesian coordinate space.

Referring first to FIG. 5A, a given emitter 4 (e.g., emitter 4A or 4B) and a single object touching the display define a region of interest 52A or 52B defined by two lines emanating from the corresponding emitter, as shown. A region of interest 52A or 52B is identified, by the sensors 5, by the shadow cast by the object upon the sensors 5. FIG. 5A shows an example of the change in sensor output signal 56A or 56B, across the sensor arrays 5 on the vertical edges of the display area, caused by shadows of the object from emitters 4A and 4B. A simple threshold function can be applied to detect the shadow, as described above.

The intersection of the regions of interest from any two emitters 4 defines an intersection region 51. The mathematics of computing the intersection region 51 based on the identified object shadows are simple and need not be discussed here. In a single touch scenario, the intersection region 51 is a quadrilateral-shaped region, which can be used to define the touch region 53. For example, the touch region 43 can be defined as the largest ellipse that fits completely within the intersection region 51. Likewise, the computation of the touch region 43 is straightforward and need not be discussed here.

In a system with four emitters (e.g., one at each corner of the display), a single touch point will result in six intersecting regions of interest, one for each of the six possible light source combinations (A:B, A:C, A:D, B:C, B:D, C:D). Although several “ghost regions” (false touch regions) 55 will result (see FIG. 5B), they are easily identified and ignored, because they have no corroboration from the other emitter pairs. With three emitters (e.g., 4A, 4B, 4C), two simultaneous touch points can be unambiguously detected, as shown in FIG. 5B. With four emitters (e.g., 4A, 4B, 4C, 4D), three simultaneous touch points can be unambiguously detected, as shown in FIG. 5C. With the addition of state tracking (i.e., tracking the relative timing of consecutive touches), the system could effectively detect more than three simultaneous touch points (or it could detect three simultaneous touches with only two emitters), although it would be at the expense of more complex algorithms.

Note that the distribution of the laser beam energy along the sensors 5 can be very uneven. At best, the light distribution falls as 1/R with the distance R from the emitter 4, when optics are used to generate a fan beam. At worst, the dependency is 1/R², when diffraction effects become prevalent. The worst case horizontal variation in beam strength for an even beam would be sin(tan⁻¹(9/16))²=0.24. At least one of the following two complimentary solutions can be used to solve this problem.

The first solution is to form the light source beam shaper 7 so that it distributes the light density in a pattern that is perceived by all of the sensors 7 as equivalent. The second is that sensors 5 can be grouped into multiple subarrays, where each subarray has its sensitivity adjusted dynamically so that its output is close to maximum but not saturated. This second solution can be thought of as an electronic shutter. The sensitivity adjustment can take place continuously but with a long time constant, e.g., seconds or minutes, as mentioned above.

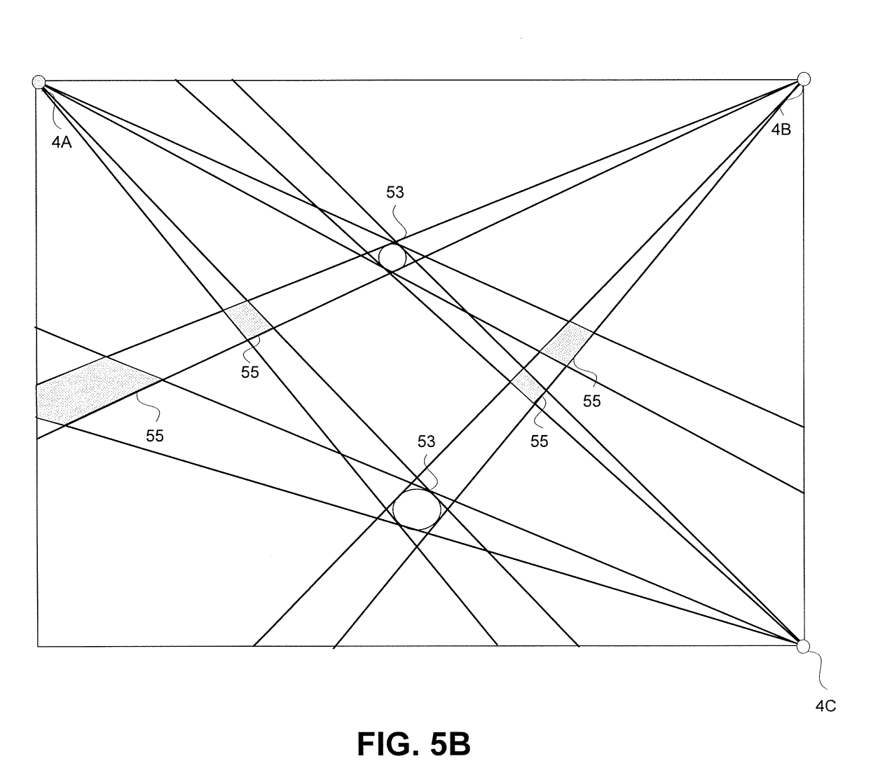

FIG. 6 illustrates the relevant elements of the processing unit 6, according to one embodiment. The processing device 6 includes a central processing unit (CPU) 45 and, coupled to the CPU 45, the touch location processor 40, a display controller 46, a memory 47 and a communication device 48. The CPU 45 controls the overall operation of the touch screen display system 1. The touch location processor 40 receives outputs from the sensors 5 and computes the location at which an object touches or comes into close proximity with the display screen 2 as described above. The touch location processor 40 provides its output to the CPU 45. The interface between the touch location processor and the CPU can be implemented, for example, by using human interface device (HID) protocol over universal serial bus (USB). The display controller 46 controls the output of the display device 2.

The CPU 45, display controller 46 and touch location processor 40 each can be or can include, for example, one or more programmable microprocessors, microcontrollers, application-specific integrated circuits (ASICs), field programmable gate arrays (FPGAs), programmable logic devices (PLDs), or other similar device or combination of such devices.

The memory 47 provides temporary and/or long-term storage of instructions and/or data for use by the CPU 45, the display controller 46 and/or the touch location processor 40. Memory 47 can be or can include one or more volatile and/or nonvolatile storage devices, such as random access memory (RAM), read-only memory (ROM), flash memory, solid-state drives, or the like.

The communication device 48 enables the processing device 6 to communicate with one or more external devices. The communication device 48 can be or can include, for example, an Inter-integrated circuit (12C) bus connector, a peripheral component interconnect (PCI) family bus connector, a USB connector, an Ethernet or Fibre Channel adapter, or any other conventional or convenient type of communication device.

The sensors 5 can be implemented in the form of multiple sensor modules, which can be constructed on single-layered printed circuit boards (PCBs). A chain of connected PCBs with their sensor arrays precisely aligned can be employed. In one embodiment, each sensor module includes 10 2-cm linear arrays of optical sensors that have 2,000 DPI linear resolutions. Similar commodity optical sensor arrays are currently available on the market at 200 DPI resolution. These types of sensors are commonly referred to as CIS sensors. Gaps between the sensor elements are sub-millimeter, e.g., 0.1 mm. In one embodiment, each edge of the bezel has several such sensor modules linearly aligned.

To compensate for possible speed limitations of the sensor elements, each sensor module (array) can have its own data acquisition channel to achieve faster data acquisition for the entire system. Alternatively, two or more sensor modules may be grouped into a single data acquisition channel, or different subsets of a given sensor module can be grouped into a single data acquisition channel. The software/firmware of the system can logically stitch together the outputs of the various sensor groups (data acquisition channels), so that the effect is as if each edge of the bezel (e.g., top, bottom, left, right) is one continuous sensor array.

The grouping of sensor modules can be based on speed limitations of the sensor elements and the desired overall response time of the system. In particular, if the detection element is a CCD device, the detection element needs time to charge. Once the sensor elements in an array have been charged with the pattern of light from a given emitter, the output of each sensor element can be read via an analog shift process into an analog-to-digital converter (ADC) for further processing.

Consider, for example, a scenario in which a 1 ms overall response time is desired. In that case, with a four emitter system each sensor element can be exposed to light for a maximum 250 μs max, assuming the emitters are operated in sequence. Further, each sensor element is used for half of the total round-robin time; for example, a sensor element on the bottom edge of the display is only used when the top-left and top-right emitters are being used and is not used when the lower-left and lower-right emitters are used. With proper sequencing, this implies that for a 1 ms desired response time, a sensor element can be given 250 μs to charge and 250 μs to shift its data out. Depending on the number of elements on a given edge of the bezel (e.g., the bottom edge), this edge may need to be broken down into subgroups of sensors with parallel data acquisition, to meet the speed limitations of the sensor elements.

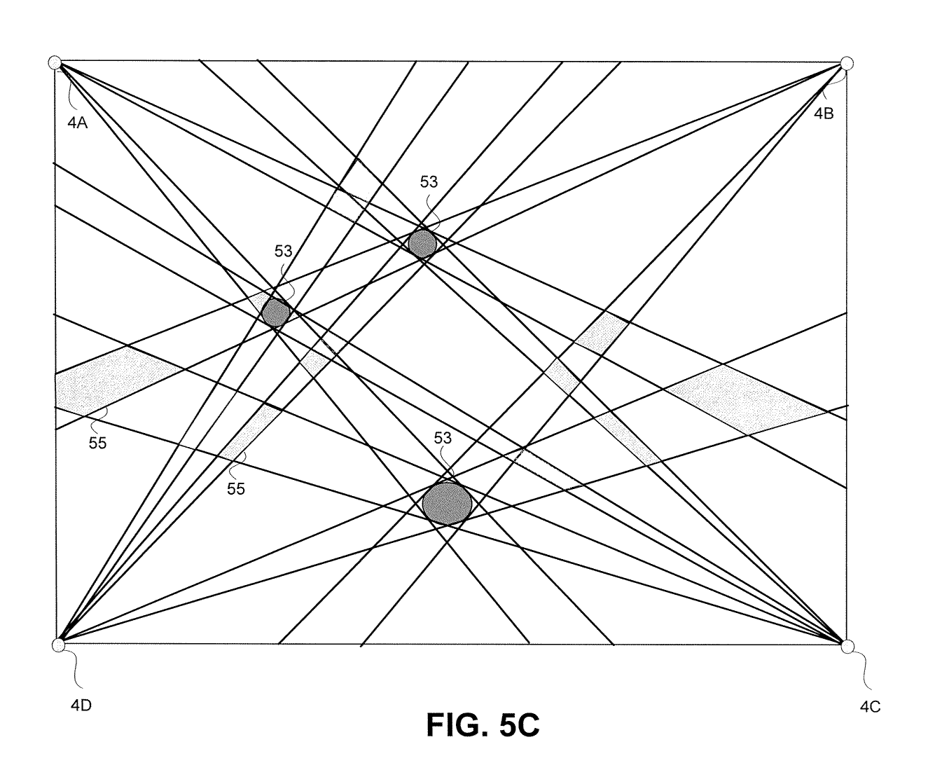

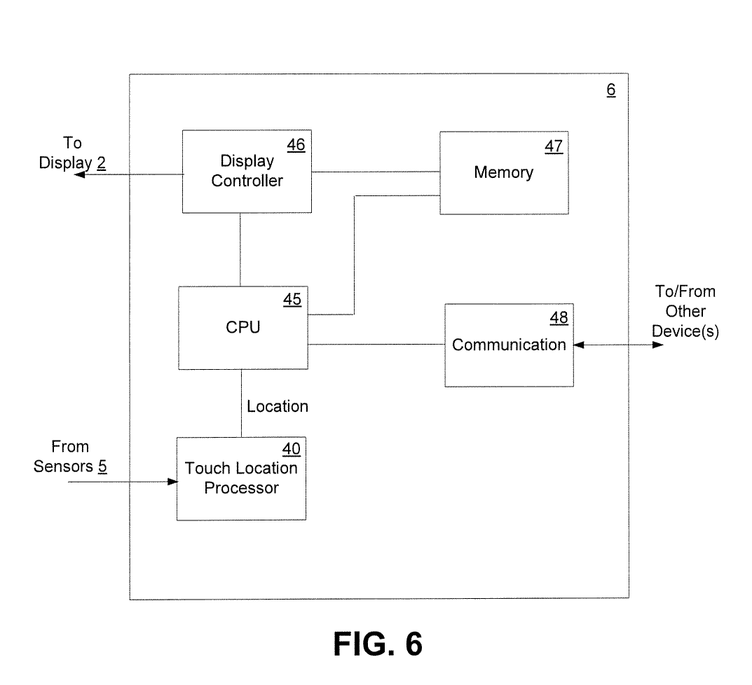

FIG. 7 shows a cross-sectional view of the display according to one embodiment, as viewed perpendicular to the plane of the display screen 2, showing how the system can be constructed. The laser emitters 4 and the sensors 5 are mounted as close to the surface 71 of the display substrate's (which may be glass, for example) as possible, with the sensors 5 being closest. As shown in FIG. 8, strips of sensor PCBs 81 oriented orthogonal to the display screen substrate 71 can be used, with the chain of adjacent PCBs 81 touching the substrate and the sensors being about 1 mm away from the substrate vertically. Pairs of adjacent PCBs can be coupled together with appropriate connectors 82, as shown.

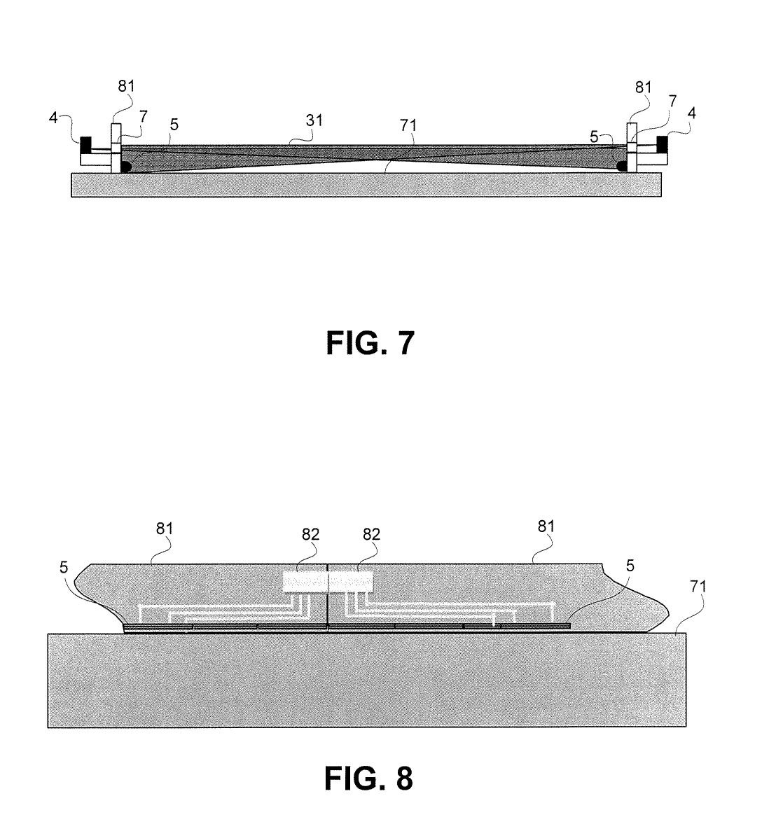

Referring to FIG. 9, in at least one embodiment the laser emitters 4 are positioned at the corners of the display screen. Four laser emitters 4, one in each corner, provide for reliable multi-touch and multi-user capability, as explained above. Two adjacent PCBs 81 are coupled together at each corner (i.e., one PCB on each adjacent side of the display). A slit 91 in the PCBs 81 can be provided at the corners, as shown, to allow for the passage of the laser light from the laser emitter 4 and beam shaper 7.

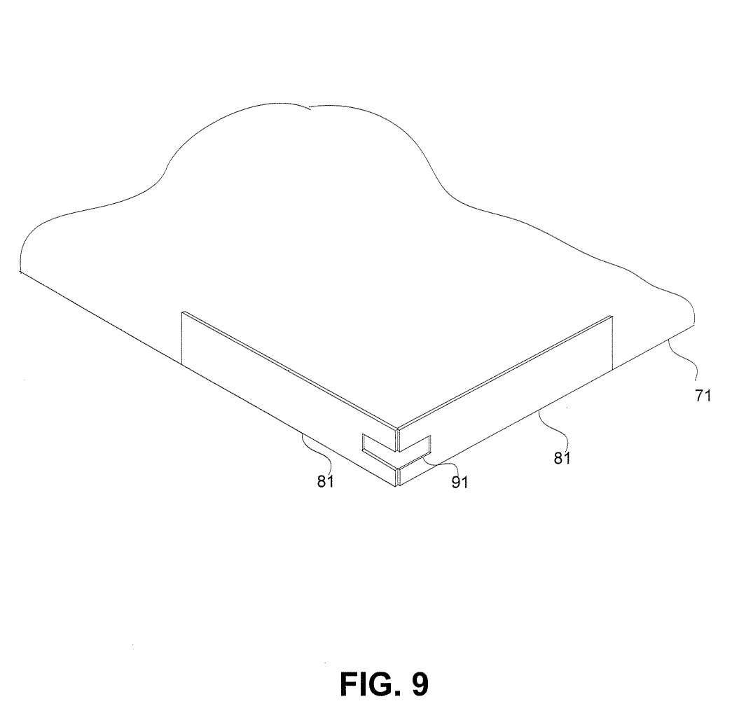

Referring to FIG. 10, a prism or other similar waveguide 101 can be added to the optical path, if desired, to allow some elevation of the sensors 5 and the laser emitters 4 from the surface 71 of the display screen 2, as shown in FIG. 10. An appropriate cover 102 can be provided, as shown, to reduce accumulation of dust or other debris on the waveguide's surfaces.

Vertical alignment of the laser emitters 4 can be accomplished at the factory with, for example, micrometric screws with very high accuracy. Similarly, a mechanism (e.g., jack screws or a similar mechanism) can also be provided to compensate for physical misalignment that may occur in the field, such as frame bending induced by bolting the display to a wall.

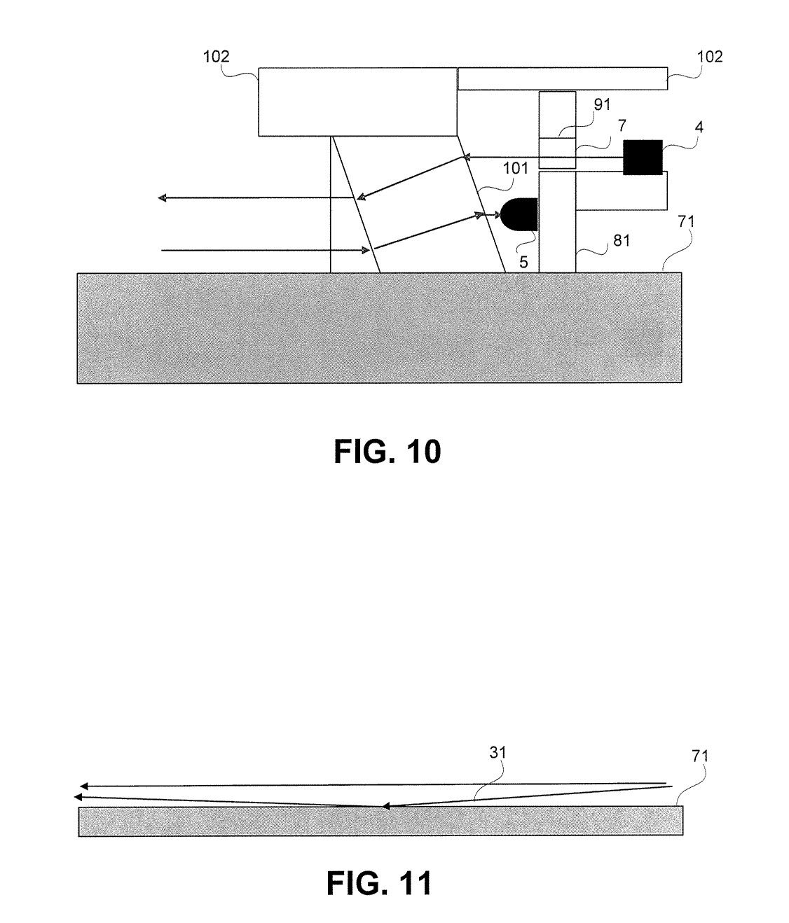

A laser emitter 4 and/or its associated beam shaper(s) can also be oriented to bounce its emitted laser beam 22 off the surface 71 of the display screen substrate, as shown in FIG. 11, thus making the fan of light closer to the surface, effectively making the laser beam 31 narrower in the vertical direction.

A common design issue for pure optical touch sensors as well as capacitive touch sensors is pre-touch. A touch event can be generated even if there is no physical touch. While this is quite acceptable for pressing buttons and manipulating windows, problems occur when attempting fine drawing and writing. A common manifestation of the problem happens when a cursive letter “i” is drawn: the dot becomes connected to the body.

One approach that helps to reduce this problem is to keep the emitters 4 and the sensors 5 in the same plane, or nearly the same plane, parallel to the display surface. Another approach, which can be complementary to the first approach, is to use a piezoelectric transducer attached to the touch screen substrate, to detect the acoustic event of touching it. With currently available technology, acoustic waves generated by the touch can be used even to detect the position of the touch. Dispersive signal technology (DST) touch screens are fully based on this effect. However, if the intent is only to detect the act of touch, not the position, this can be done with simple thresholding of the signal from the piezoelectric transducer.

The techniques introduced above can be implemented in software and/or firmware in conjunction with programmable circuitry, or entirely in special-purpose hardwired circuitry, or in a combination of such forms. Special-purpose hardwired circuitry may be in the form of, for example, one or more ASICs, PLDs, FPGAs, etc.

Software or firmware to implement the techniques introduced here may be stored on a machine-readable medium and may be executed by one or more general-purpose or special-purpose programmable microprocessors. A “machine-readable medium”, as the term is used herein, includes any mechanism that can store information in a form accessible by a machine. For example, a machine-readable storage medium can include recordable/non-recordable media (e.g., read-only memory (ROM); random access memory (RAM); magnetic disk storage media; optical storage media; flash memory devices; etc.), etc.

The term “logic”, as used herein, can include, for example, special-purpose hardwired circuitry, software and/or firmware in conjunction with programmable circuitry, or a combination thereof.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A display system comprising:
a display screen;
a plurality of electromagnetic radiation emitters disposed at a periphery of the display screen;
a plurality of beam shapers, each to shape emissions from a separate one of the emitters into a fan beam pattern;
a plurality of detectors disposed at the periphery of the display screen to detect electromagnetic emissions of the emitters; and
a processor configured to determine a parameter descriptive of a touch event in which an object touches the display screen, based on outputs of the detectors.

2. A display system as recited in claim 1, wherein each of the emitters is a laser emitter.

3. A display system as recited in claim 1, wherein the processor is configured to determine the location where an object touches the display surface by determining locations of shadows of emissions from the emitters, cast by the object, upon two or more of the detectors.

4. A display system as recited in claim 1, wherein the processor is configured to identify and eliminate from consideration false touch points, based on outputs of two or more of the detectors responsive to shadows cast by the object from the emitters.

5. A display system as recited in claim 4, wherein the processor is configured to detect two or more simultaneous real touch regions on the display, without using touch point state information, based on the outputs of two or more of the detectors.

6. A display system as recited in claim 1, wherein the plurality of detectors comprise a plurality of contact image sensors (CIS).

7. A display system as recited in claim 1, wherein the system is configured to cause the emitters to emit radiation sequentially in a repeating loop.

8. A display system as recited in claim 1, wherein each of the emitters emits radiation along a fixed path, and wherein each of the beam shapers modifies a radiation pattern from a different one of the emitters to be an approximately 90-degree pattern parallel to a display surface of the display screen and to collimate said radiation in a direction perpendicular to the display surface.

9. A display system as recited in claim 1, wherein each of the emitters is controllable to sweep a radiation beam emitted therefrom through a range of angles across a display surface of the display screen.

10. A display system as recited in claim 1, wherein the display screen has a display surface with a plurality of corners, and wherein each of the emitters is disposed at a different one of said corners.

11. A display system as recited in claim 1, wherein the plurality of detectors are mounted on a plurality of circuit boards physically coupled together, wherein the detectors on at least two of the plurality of circuit boards are treated as a single contiguous linear array.

12. A display system as recited in claim 1, wherein the plurality of detectors are associated with a plurality of data acquisition channels, and wherein outputs of the plurality of data acquisition channels are combined such that the plurality of detectors are viewed as a single contiguous detector array.

13. A display system as recited in claim 1, further comprising an acoustic sensor to detect an event of an object touching a display surface of the display screen.

14. A display system comprising:
a display screen having a display surface with a plurality of corners and a plurality of edges;
a plurality of laser emitters, each disposed at a different corner of the display surface, to emit laser light over the display surface;
a plurality of optical waveguides, each to modify a radiation pattern of laser light from a different one of the laser emitters to be an approximately 90-degree pattern parallel and proximal to the display surface and to collimate said laser light in a direction perpendicular to the display surface;
a plurality of optical detectors disposed in linear configurations along edges of the display surface, to detect laser light from the laser emitters via the optical waveguides; and
a processor to determine a location where an object touches the display surface, based on outputs of the optical detectors, by determining locations of shadows of laser light cast upon two or more of the detectors.

15. A display system as recited in claim 14, wherein the plurality of optical detectors comprise a plurality of contact image sensors (CIS).

16. A display system as recited in claim 14, wherein the plurality of detectors are mounted on a plurality of circuit boards physically together, and wherein the detectors on at least two of the plurality of circuit boards are treated as a single contiguous linear array.

17. A display system as recited in claim 14, wherein the plurality of detectors are associated with a plurality of data acquisition channels, and wherein outputs of the plurality of data acquisition channels are combined such that the plurality of detectors are viewed as a single contiguous detector array.

18. A display system as recited in claim 14, further comprising an acoustic sensor to detect an event of an object touching the display surface.

19. A display system as recited in claim 14, wherein the system is configured to cause the laser emitters to fire sequentially in a repeating loop.

20. A method comprising:
producing a fan-shaped radiation beam from each of a plurality of locations at a periphery of a display screen to produce a plurality of fan-shaped radiation beams;
detecting radiation from the radiation beams at a plurality of detectors positioned about the periphery of the display screen; and
determining a location where an object touches a surface of the display screen, based on outputs of the detectors.

21. A method as recited in claim 20, wherein each of the plurality of radiation beams is a laser beam.

22. A method as recited in claim 21, wherein the display surface has a plurality of corners, and wherein producing a radiation beam from each of a plurality of locations comprises emitting a fan-shaped radiation beam from each of two or more of said corners.

23. A method as recited in claim 22, wherein emitting a fan-shaped radiation beam from each of two or more of said corners comprises:
emitting fan-shaped radiation beam sequentially from each of said two or more corners in a repeating loop.

24. A method as recited in claim 21, wherein determining the location comprises determining locations of shadows of radiation cast by the object upon two or more of the detectors.

25. A method as recited in claim 21, wherein producing the fan-shaped radiation beam comprises:
converting each of the fan-shaped radiation beams into an approximately 90-degree pattern parallel to the display surface; and
collimating each of the fan-shaped radiation beams in a direction perpendicular to the display surface.

26. A method as recited in claim 21, wherein producing the fan-shaped radiation beams comprises:
sweeping each of the radiation beams through a range of angles across the display surface.

27. A method as recited in claim 21, further comprising:
associating the plurality of detectors with a plurality of data acquisition channels, and
combining outputs of the plurality of data acquisition channels such that the plurality of detectors are viewed as a single contiguous detector array.

28. A method as recited in claim 21, further comprising:
acoustically detecting an event of an object touching a display surface of the display screen.

29. A method comprising:
producing a fan-shaped laser beam over a display surface of a display screen from a location at each of a plurality of corners of the display surface, to produce a plurality of fan-shaped laser beams;
detecting light of the laser beams at a plurality of detectors positioned about a periphery of the display surface; and
determining a location where an object touches the display surface based on outputs of the detectors, by determining locations of shadows of laser light cast upon two or more of the detectors.

30. A method as recited in claim 29, wherein producing a laser beam over a display surface of a display screen from locations at each of a plurality of corners of the display surface comprises:
emitting laser beams sequentially from each of the plurality of corners of the display surface in a repeating loop.

31. A method as recited in claim 29, wherein producing the laser beams comprises:
optically converting each of the laser beams into an approximately 90-degree pattern parallel and proximal to the display surface; and
collimating each of the laser beams in a direction perpendicular to the display surface.

32. A method as recited in claim 29, wherein producing the laser beams comprises:
sweeping each of the laser beams through a range of angles across the display surface.

33. A method as recited in claim 29, further comprising:
associating the plurality of detectors with a plurality of data acquisition channels, and combining outputs of the plurality of data acquisition channels such that the plurality of detectors are viewed as a single contiguous detector array.

34. A method as recited in claim 29, further comprising:
acoustically detecting an event of an object touching a display surface of the display screen.
